(19) United States
(12) Patent Application Publication
(10) Pub. No.: US 2024/0311904 A1
(43) Pub. Date: Sep. 19, 2024

(54) SYSTEMS AND METHODS FOR LEASE DEFERRAL BASED ON WEATHER DATA

(71) Applicant: Toyota Motor North America, Inc., Plano, TX (US)

(72) Inventors: Amber LEWIS, Garland, TX (US); Joshua BATIE, Frisco, TX (US); Jeremy GUCK, Cedar Rapids, IA (US); Marc MURRIN, Prosper, TX (US)

(73) Assignees: Toyota Motor North America, Inc., Plano, TX (US); Toyota Jidosha Kabushiki Kaisha, Toyota-shi (JP)

(21) Appl. No.: 18/182,840

(22) Filed: Mar. 13, 2023

(51) Int. Cl. G06Q 30/0645; G01W 1/10; G06Q 50/30

(52) U.S. Cl. CPC G06Q 30/0645; G01W 1/10; G06Q 50/40

(57) ABSTRACT

Embodiments of the present disclosure are directed to a lease deferral system. The system includes a computing device including a memory unit storing a lease history of a plurality of leased vehicles. The computing device is configured to retrieve, from a weather reporting system, information pertaining to a weather event defined by a geographic area, determine one or more affected leased vehicles, and determine an eligible leased vehicle from the one or more affected leased vehicles for a lease deferral based on the weather event and the lease history of the one or more affected leased vehicles. The computing device is further configured to transmit an electronic notification to a customer of the eligible leased vehicle, the electronic notification including a lease deferral offer, and prompt the customer, within the electronic notification, to accept the lease deferral.

### TECHNICAL FIELD

The present specification generally relates to systems and methods for generating lease deferrals to customers of a leasing service.

### BACKGROUND

A lessor often leases a vehicle to a customer when the customer prefers to rent the vehicle for a certain period of time rather than buy the vehicle. Leasing results in lower monthly payments for the customer. However, the customer may not be able to make lease payments due to a negative financial event. In some cases, a large number of customers in a particular geographical area may not be able to make lease payments due to an adverse weather event, such as a blizzard, tornado, or earthquake. Thus, the customer may request to delay lease payments (i.e. request a lease deferral) when the adverse weather event has occurred.

Thus, there is a need for processes to determine and handle lease deferrals in response to adverse weather events.

### SUMMARY

In one embodiment, an automatic lease deferral system is disclosed. The automatic lease deferral system includes a computing device including a memory unit storing a lease history of a plurality of leased vehicles. The computing device is configured to retrieve, from a weather reporting system, information pertaining to a weather event defined by a geographic area, determine one or more affected leased vehicles from the lease history of the plurality of leased vehicles based on the geographic area of the weather event, and determine an eligible leased vehicle from the one or more affected leased vehicles for a lease deferral based on the weather event and the lease history of the one or more affected leased vehicles. The computing device is also configured to transmit an electronic notification to a customer of the eligible leased vehicle, the electronic notification including a lease deferral offer and prompt the customer, within the electronic notification, to accept the lease deferral.

In another embodiment, a method for providing lease deferrals is disclosed. The method includes retrieving, from a weather reporting system, information pertaining to a weather event defined by a geographic area, determining one or more affected leased vehicles from a lease history of a plurality of leased vehicles based on the geographic area of the weather event, and determining an eligible leased vehicle from the one or more affected leased vehicles for a lease deferral based on the weather event and the lease history of the one or more affected leased vehicles. The method further includes transmitting an electronic notification to a customer of the eligible leased vehicle, the electronic notification including a lease deferral offer and prompting the customer, within the electronic notification, to accept the lease deferral.

In yet another embodiment, an automatic lease deferral system is disclosed that includes a computing device including a memory unit storing a lease history of a plurality of leased vehicles. The computing device is configured to retrieve, from a weather reporting system, information pertaining to a weather event defined by a geographic area, determine one or more affected leased vehicles from the lease history of the plurality of leased vehicles based on the geographic area of the weather event, and determine an eligible leased vehicle from the one or more affected leased vehicles for a lease deferral based on the weather event and the lease history of the one or more affected leased vehicles. The computing device is also configured to transmit an electronic notification to a customer of the eligible leased vehicle, the electronic notification including a lease deferral offer and prompt the customer, within the electronic notification, to accept the lease deferral. The system also includes a machine learning model. The machine learning model adjusts an algorithm of the computing device that determines the eligible leased vehicle based on the lease history.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative embodiment of a lease deferral system according to one or more embodiments shown and described herein;

FIG. 2 depicts a flowchart of an example method for providing lease deferrals according to one or more embodiments shown and described herein;

FIG. 3 schematically depicts an illustrative embodiment of geographic areas subject to adverse weather events according to one or more embodiments shown and described herein; and

FIG. 4 schematically depicts an illustrative method for applying machine learning for offering lease deferrals in accordance with one or more example embodiments.

### DETAILED DESCRIPTION

Embodiments described herein relate to systems and methods for offering lease deferrals to customers (i.e., lessees) that have been subject to a weather event. Customers of a leasing service may not be able to make lease payments and may seek a lease deferral. The customers may not be able to make lease payments for a variety of reasons, such as a lapse in employment, an unexpected expense, or unexpected medical issues. An unexpected expense may originate from the weather event, particularly, if the weather event is a severe adverse weather event. The weather event may bring forth unexpected expenses for customers in the form of housing repairs, medical bills, lapse in employment, increased food costs, or various other unexpected expenses due to the weather event.

The weather event may be defined by a geographic area. The customers located within the geographic area affected by the weather event may request a lease deferral. Obtaining and processing lease deferral requests from customers located within the geographic area affected by the weather event may be difficult and time consuming, especially if the geographic area affected by the weather event is substantial. Moreover, the customers affected by the weather event may not have the time or resources to request a lease deferral following the weather event.

Additionally, the lessor may receive a large number of lease deferral requests from customers when the adverse weather event has occurred, making it difficult for the customers to contact the lessor. Also, processing the lease deferral requests and determining whether certain customers are approved is time consuming and difficult. Moreover, the customer may not be able to call due to the unavailability of cell phone service after the adverse weather event. Furthermore, by providing an automated lease deferral system, more accurate information such as the location of the vehicle during the occurrence of a weather event can be obtained and utilized in making a lease deferral decisions. Accordingly, an automatic lease deferral system that automatically offers lease deferrals to customers affected by a weather event in a particular geographic area is provided by interconnecting vehicle information such as location data obtained from a vehicle, lease information from a vehicle lease, and weather information pertaining to weather events.

As will be described herein, lease deferrals may be automatically offered to customers located within a geographic area affected by a weather event. Systems and methods for automatically detecting customers within the geographic area affected by the weather event and automatically offering such customers lease deferrals will now be described herein.

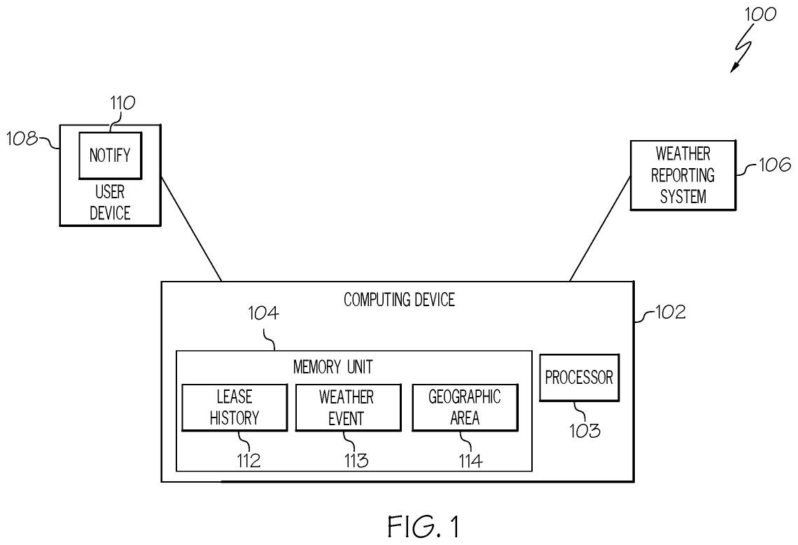

Turning now to the drawings wherein like numbers refer to like structures, and particularly to FIG. 1, an illustrative embodiment of a lease deferral system 100 is depicted. As shown in the diagram of FIG. 1, the lease deferral system 100 includes a computing device 102. The computing device 102 includes a memory unit 104 and a processor 103. The lease deferral system 100 is also communicatively coupled to a weather reporting system 106 and a user device 108. In embodiments, which will be described in detail herein, the computing device 102 processes information from the weather reporting system 106 and transmits an electronic notification 110 of a lease deferral offer to the user device 108.

The computing device 102 may be any device or combination of components comprising a processor 103 and a memory unit 104 (e.g., a non-transitory computer readable memory). The processor 103 may be any device capable of executing the machine-readable instruction set stored in the memory unit 104. Accordingly, the processor 103 may be an electric controller, an integrated circuit, a microchip, a computer, or any other computing device. The processor 103 is communicatively coupled to the other components of the system 100. Specifically, each of the components may operate as a node that may send and/or receive data. While the embodiment depicted in FIG. 1 includes a single processor 103, other embodiments may include more than one processor 103.

The memory unit 104 of the computing device 102 may store a lease history 112 of a plurality of leased vehicles. The lease history 112 stored in the memory unit 104 may include customer information of a customer. The lease history 112 may include a lease origination location. The lease origination location may be a geographic area 114 in which the customer originally leased a vehicle. The geographic area 114 may include a zip code, town, city, state, or any other suitable geographic information.

The geographic area 114 may also be recognized by the computing device 102 in real-time, through a global positioning system (GPS) of the vehicle. Therefore, the geographic area 114 may be dynamic, such that the geographic area 114 may change as the customer drives the vehicle from one location to another location. Thus, the one or more affected leased vehicles may be determined by a real-time geographic location of the plurality of leased vehicles, rather than the geographic area 114 in which the customer originally leased the vehicle. It is noted that the real-time geographic location of the plurality of leased vehicles and the geographic area 114 in which the customer originally leased the vehicle may be different.

The lease history 112 stored in the memory unit 104 may also include customer information such as a customer credit score, a history of lease payments, a maximum number of lease deferrals, a previous number of lease deferrals, or any other suitable customer information. The maximum number of lease deferrals may represent a maximum number of lease deferrals that may be offered to the customer, based on the number of previous lease deferrals. The lease history 112 may be manually entered into the memory unit 104 by the lessor. Alternatively, the lease history 112 may be uploaded from an outside source, such as a customer database or a credit reporting system. The computing device 102 may use any of the customer information stored on the lease history 112 to determine an eligible leased vehicle.

The memory unit 104 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. As discussed hereinabove, the memory unit 104 may store the lease history 112. Alternatively, the memory unit 104 may store machine-readable instructions, such that the machine-readable instructions can be accessed and executed by the processor 103 of the computing device 102.

The machine-readable instruction set may comprise logic or algorithm(s) written in any programming language of any generation (e.g., 1GL, 2GL, 3GL, 4GL, or 5GL) such as, for example, machine language that may be directly executed by the processor 103, or assembly language, object-oriented programming (OOP), scripting languages, microcode, etc., that may be compiled or assembled into machine readable instructions and stored in the memory unit 104. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 1 includes a single memory unit 104, other embodiments may include more than one memory unit 104.

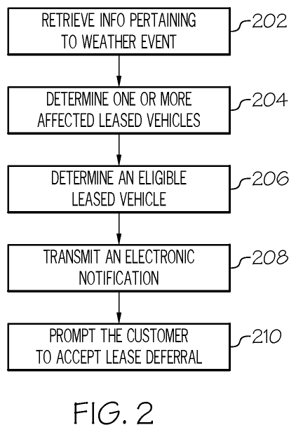

Referring now to FIG. 2, the computing device 102 is configured to execute various commands in order to notify the customer of the lease deferral offer, all of which are further explained below. At block 202 the computing device 102 retrieves, from the weather reporting system 106, information pertaining to a weather event 113 defined by the geographic area 114. The computing device 102 may obtain information from the weather reporting system 106 by querying the weather reporting system 106 with location identification information such as a zip code, longitude and latitude coordinates, or the like. In some embodiments, the computing device 102 or the weather reporting system 106 may be configured to trigger a request or a report when a weather event having a predefined severity occurs. For example, a weather event of a predefined severity may include the occurrence of a hurricane, a rain or snow fall rate greater than a predetermined rate of accumulation, a total amount of rain or snow fall, the occurrence of a thunderstorm with hail and/or wind above a threshold, an occurrence of a blizzard, or other severe weather event which may be predefined in the weather reporting system 106 or the computing device 102. In some embodiments, the weather reporting system 106 continuously provides the computing device 102 with weather data for a coverage area, for example, the 48 contiguous states, and the computing device 102 may be configured to analyze the weather data for the occurrence of a severe weather event which may trigger issuance of lease deferrals. Additional examples of information pertaining to the weather event 113 is discussed herein below.

At block 204, the computing device 102 determines one or more affected leased vehicles from the lease history 112 of the plurality of leased vehicles, based on the geographic area 114 of the weather event 113. For example, the computing device 102 may retrieve GPS location data from leased vehicles and determine their respective locations during the weather event 113. Additionally, based on the location information for the leased vehicle, the computing device 102 may determine whether the vehicle was located outside during the weather event, either parked or traveling, or stored inside a garage or other structure. In some instances, a determination as to whether the vehicle is stored or parked outside or inside may be obtained from an owner's lease profile or insurance information, which may also be retrieved and/or utilized by the system 100 described herein. If a vehicle located within the geographic area 114 of the weather event 113 was determined to be stored or parked inside a structure or garage, then the vehicle may be excluded from a list of affected leased vehicles.

At block 206, the computing device 102 then determines the eligible leased vehicle from the one or more affected leased vehicles for a lease deferral offer based on the weather event 113 and the lease history 112. Eligibility, as discussed in more detail herein, may be determined based on a lessee's payment history, whether previous deferrals were offered and/or utilized, whether the lessee has opted-in or out of the option for automatic lease deferrals, and the like. In some embodiments, the lessee's payment history may be analyzed to determine whether they have missed a number of payments over a predefined period of time of the lease. For example, the predefined period of time may be the previous 3 months, 6 months, 9, months, year or over the term of the lease. If a number of missed payments is greater than a threshold value for the predefined period of time, then the lessee will be disqualified from an option for a lease deferral.

The computing device 102 then transmits the electronic notification 110 to the customer of the eligible leased vehicle at block 208 and prompts the customer to accept the lease deferral within the electronic notification 110 at block 210. Each of these commands are discussed further below.

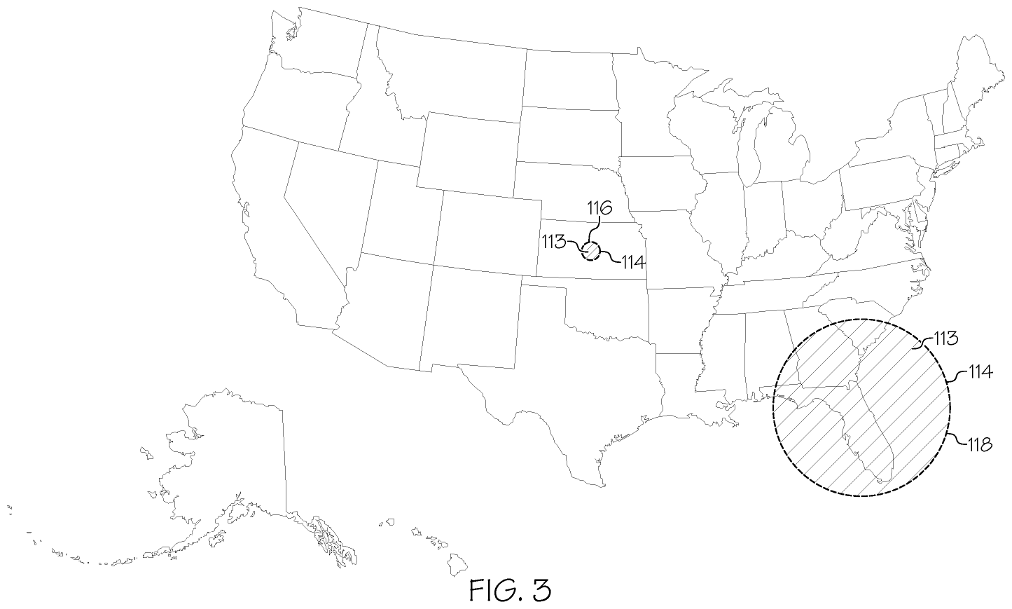

As depicted in FIG. 3, the weather reporting system 106 may produce information pertaining to a weather event 113 defined by the geographic area 114. The weather event 113 may include an earthquake, wildfire, heavy rain, lightning, hurricane, tornado, hail storm, or any other adverse weather. The weather event 113 may be defined by the geographic area 114. For example, a tornado 116 may affect a 30 mile radius in Kansas. On the other hand, a hurricane 118 may affect a 300 mile radius spanning a crossed Florida, Louisiana, Georgia, and South Carolina. Thus, the weather reporting system 106 may produce information for small-scale weather events 113 or large-scale weather events 113. The weather reporting system 106 may utilize satellite technology, or any other suitable technology suitable for detecting the weather event 113. In some embodiments, the weather reporting system 106 includes a plurality of local, individual weather reporting systems 106 communicatively coupled through a network.

The weather reporting system 106 may predict future weather events. For example, the weather reporting system 106 may anticipate, based on meteorological information, that the weather event 113 is predicted to occur in the geographic area 114. The weather reporting system 106 may anticipate the weather event 113 minutes, hours, days, weeks, or months in advance of a time the weather event 113 occurs.

The weather reporting system 106 may generate information pertaining to the weather event 113, such as a rating of the weather event 113. For example, a category five hurricane may be rated as a 100/100 by the weather reporting system 106; a category one hurricane may be rated a 60/100 by the weather reporting system 106; and a small tropical storm may be rated a 20/100 by the weather reporting system 106. The weather reporting system 106 may rate the weather event 113 differently depending on the geographic area 114 in which the weather event 113 occurs. For example, six inches of snow in Texas may be rated a 90/100, while six inches of snow in Michigan may be rated a 20/100. Thus, the weather reporting system 106 may take into account by the severity of the weather event 113 and the geographic area 114 when generating the rating of the weather event 113. The weather reporting system 106 may also rate the weather event 113 based on a history of recent weather events. For example, if the geographic area 114 recently experienced a category five hurricane rated at 100/100, then a category one hurricane the next week may be rated higher than usual, possibly an 80/100 rather than a 60/100, because of the severity of the recent category five hurricane.

The computing device 102 may be communicatively coupled to the weather reporting system 106, such that the computing device 102 receives the information pertaining to the weather event 113. The information pertaining to the weather event 113 that the computing device 102 may receive from the weather reporting system 106 include the rating of the weather event 113, the geographic area 114 that the weather event 113 covered, or any other suitable information regarding the weather event 113. The computing device 102 may also determine whether the information pertaining to the weather event 113 exceeds a weather event threshold. For example, the weather event threshold may be a 10/100, such that the computing device 102 does not send the lease deferral offer to any of the leased vehicles within the geographic area 114 affected by the weather event 113 with a rating of 10/100 or below.

The computing device 102 may also determine the one or more affected leased vehicles based on the lease history 112 of the plurality of leased vehicles and the geographic area 114 of the weather event 113. As discussed hereinabove, the lease history 112 of the plurality of leased vehicles may be stored in the memory unit 104, and the geographic area 114 of the weather event 113 may be detected by the weather reporting system 106.

Based on the lease history 112 and the weather event 113, the computing device 102 determines the eligible leased vehicle from the one or more affected leased vehicles. Information from both the lease history 112 and the weather event 113 are considered by the computing device 102 when determining whether a particular leased vehicle is eligible. For example, if the customer of the leased vehicle has a credit score of 800, no prior lease deferrals, and the rating of the weather event 113 is 80/100, the computing device 102 may offer the customer the lease deferral offer if the eligible leased vehicle was located within the geographic area 114 at the time of the weather event 113. In other embodiments, if the customer of the leased vehicle has a credit score of 600, five prior lease deferrals, and the rating of the weather event 113 is 20/100, the computing device 102 may not offer the customer the lease deferral offer. In some embodiments, when a customer's credit score is below a predetermined score, the customer is excluded from receiving a lease deferral offer.

The computing device 102 may utilize varying thresholds for determining whether the lease deferral offer is given to the customer. An administrator may adjust the thresholds the computing device 102 utilizes or the administrator may override the grant or denial of the lease deferral offer by the computing device 102. For example, the administrator may make the lease deferral offer available to all customers of the plurality of leased vehicles within the geographic area 114 when the weather event 113 occurred if the weather event 113 had a rating of over 90/100. The administrator may also set the maximum number of lease deferrals, so that the computing device 102 may determine whether the maximum number of lease deferrals has been exceeded. The computing device 102 may not send any lease deferral offers to customers that have exceeded the maximum number of lease deferrals.

The computing device 102 also transmits the electronic notification 110 to a customer of the eligible leased vehicle. The electronic notification 110 includes a lease deferral offer. Through the electronic notification 110, the computing device 102 prompts the customer of the eligible leased vehicle to accept the lease deferral. The electronic notification 110 may be transmitted to the user device 108. The user device 108 may be a phone, tablet, computer, or any other suitable device capable of receiving the electronic notification 110.

In some embodiments, the electronic notification 110 includes a phone call. The phone call may prompt a response to accept or deny the lease deferral. The phone call may inform the customer of the eligible leased vehicle that the customer is eligible for the lease deferral offer. The phone call may include a voice recording that informs the customer of details of the lease deferral offer. The customer may automatically accept the lease deferral offer by saying “yes,” or reject the offer by saying “no.” In other embodiments, the voice recording may notify the customer that the lease deferral will be accepted absent any action of the customer to deny the lease deferral.

In other embodiments, the electronic notification 110 may be a push notification on the user device 108. The push notification may give the customer the option to click “accept” or “deny” on the user device 108. The electronic notification 110 may also be a text message, email, or any other form of notification the customer is capable of receiving on the user device 108. The customer may also accept or deny the lease deferral offer through all of the aforementioned forms of communication. If the customer accepts the lease deferral offer, the lease history 112 may be updated. Thus, the computing device 102 would receive an acceptance and update the lease history 112, increasing the previous number of lease deferrals.

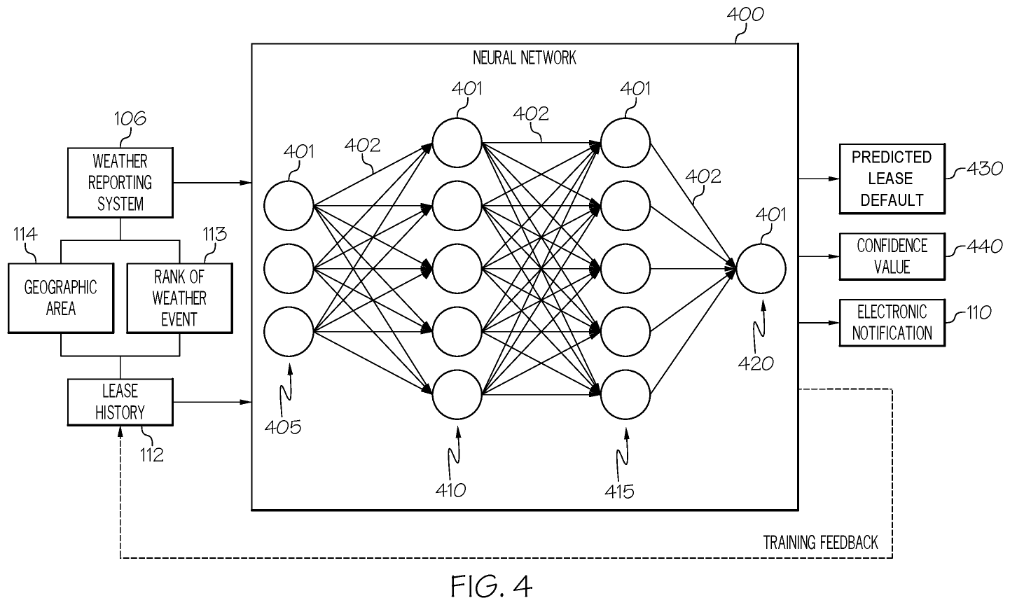

In some embodiments, the system 100 may further include a machine learning model 400, as depicted in FIG. 4. The machine learning model 400 adjusts an algorithm of the computing device 102 that determines the eligible leased vehicle based on the lease history 112 and weather reporting system 106. FIG. 4 depicts an illustrative diagram for training a neural network for predicting whether the customer will pay the lease if the lease deferral offer is issued. It should be understood that a neural network is only one example of the machine learning model 400 that can be implemented in the embodiments described herein. For example, the machine learning model 400 may be a supervised learning models, unsupervised learning models, semi-supervised learning models, reinforcement learning models, deep learning models generative models, transfer learning models, neural networks, or the like. In some embodiments, the neural network may include one or more layers 405, 410, 415, 420, having one or more nodes 401, connected by node connections 402. The one or more layers 405, 410, 415, 420 may include an input layer 405, one or more hidden layers 410, 415, and an output layer 420. The input layer 405 represents the raw information that is fed into the neural network. For example, information from the weather reporting system 106 (the rating of the weather event 113 and the geographic area 114) and the lease history 112 may be input into the neural network at the input layer 405. The neural network processes the raw information received at the input layer 405 through nodes 401 and node connections 402. The one or more hidden layers 410, 415, depending on the inputs from the input layer 405 and the weights on the node connections 402, carry out computational activities. In other words, the hidden layers 410, 415 perform computations and transfer information from the input layer 405 to the output layer 420 through their associated nodes 401 and node connections 402.

In general, when a neural network is learning, the neural network is identifying and determining patterns within the raw information received at the input layer 405. In response, one or more parameters, for example, weights associated to node connections 402 between nodes 401, may be adjusted through a process known as back-propagation. It should be understood that there are various processes in which learning may occur, however, two general learning processes include associative mapping and regularity detection. Associative mapping refers to a learning process where a neural network learns to produce a particular pattern on the set of inputs whenever another particular pattern is applied on the set of inputs. Regularity detection refers to a learning process where the neural network learns to respond to particular properties of the input patterns. Whereas in associative mapping the neural network stores the relationships among patterns, in regularity detection the response of each unit has a particular ‘meaning’. This type of learning mechanism may be used for feature discovery and knowledge representation.

Neural networks possess knowledge that is contained in the values of the node connection weights. Modifying the knowledge stored in the network as a function of experience implies a learning rule for changing the values of the weights. Information is stored in a weight matrix W of a neural network. Learning is the determination of the weights. Following the way learning is performed, two major categories of neural networks can be distinguished: 1) fixed networks in which the weights cannot be changed (i.e., dW/dt=0) and 2) adaptive networks that are able to change their weights (i.e., dW/dt not=0). In fixed networks, the weights are fixed a priori according to the problem to solve.

In order to train a neural network to perform some task, adjustments to the weights are made in such a way that the error between the desired output and the actual output is reduced. This process may require that the neural network compute the error derivative of the weights (EW). In other words, it must calculate how the error changes as each weight is increased or decreased slightly. A back propagation algorithm is one method that is used for determining the EW.

The algorithm computes each EW by first computing the error derivative (EA), the rate at which the error changes as the activity level of a unit is changed. For output units, the EA is simply the difference between the actual and the desired output. To compute the EA for a hidden unit in the layer just before the output layer 420, first all the weights between that hidden unit and the output units to which it is connected are identified. Then, those weights are multiplied by the EAs of those output units and the products are added. This sum equals the EA for the chosen hidden unit. After calculating all the EAs in the hidden layer just before the output layer 420, in like fashion, the EAs for other layers may be computed, moving from layer to layer in a direction opposite to the way activities propagate through the neural network, hence “back propagation”. Once the EA has been computed for a unit, it is straightforward to compute the EW for each incoming connection of the unit. The EW is the product of the EA and the activity through the incoming connection. It should be understood that this is only one method in which a neural network is trained to perform a task.

Referring back to FIG. 4, the neural network may include one or more hidden layers 410, 415 that feed into one or more nodes 401 of an output layer 420. There may be one or more output layers 420 depending on the particular output the neural network is configured to generate. For example, the neural network may be trained to output a prediction of an occurrence of a lease default 430 if the lease deferral offer is issued, generate a confidence value 440 associated with the predicted lease default 430, and/or determine a degree and type of the electronic notification 110 for providing to the customer. In embodiments, the prediction of the occurrence of the predicted lease default 430 generated by the machine learning model 400 is used to adjust parameters of issuing a lease deferral or the terms of the lease deferral to avoid or mitigate additional adverse impacts to the customer and/or the lessor. For example, the predicted lease default 430 may indicate that the selection criteria is overly inclusive or will negatively affect a customer's long term payment plan, although it may be beneficial in the immediate future in response to the weather event 113. In such instances, other options such as service promotions to help address potential issues to the customer's vehicle in response to the weather event 113 may be determined and offered. In some instances, the system 100 may determine that instead of offering a lease deferral, merely providing the customer with information or an alert to contact their financial provider if the weather event 113 has negatively impacted them or their vehicle.

In other embodiments, a method for providing lease deferrals is disclosed. The method includes retrieving, from the weather reporting system 106, information pertaining to the weather event 113 defined by the geographic area 114, determining the one or more affected leased vehicles from the lease history 112 of the plurality of leased vehicles based on the geographic arca 114 of the weather event 113. The method further includes determining the eligible leased vehicle from the one or more affected leased vehicles for the lease deferral based on the weather event 113 and the lease history 112 of the one or more affected leased vehicles, transmitting the electronic notification 110 to the customer of the eligible leased vehicle, the electronic notification 110 including the lease deferral offer, and prompting the customer, within the electronic notification 110, to accept the lease deferral.

It is noted that the terms “substantial”, “substantially”, and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An automatic lease deferral system, comprising:
a computing device comprising a memory unit storing a lease history of a plurality of leased vehicles, the computing device configured to:
retrieve, from a weather reporting system, information pertaining to a weather event defined by a geographic area;
determine one or more affected leased vehicles from the lease history of the plurality of leased vehicles based on the geographic area of the weather event;
determine an eligible leased vehicle from the one or more affected leased vehicles for a lease deferral based on the weather event and the lease history of the one or more affected leased vehicles;
transmit an electronic notification to a customer of the eligible leased vehicle, the electronic notification including a lease deferral offer; and
prompt the customer, within the electronic notification, to accept the lease deferral.

2. The automatic lease deferral system of claim 1, wherein the electronic notification is configured to cause a user device to generate a push notification prompting a response to accept or deny the lease deferral.

3. The automatic lease deferral system of claim 1, wherein the electronic notification is a phone call prompting a response to accept or deny the lease deferral.

4. The automatic lease deferral system of claim 1, wherein:
the lease history of the of the plurality of leased vehicles includes a history of lease payments; and
determining the eligible leased vehicle for the lease deferral based on the history of lease payments.

5. The automatic lease deferral system of claim 4, wherein the lease history of the plurality of leased vehicles includes a customer credit score.

6. The automatic lease deferral system of claim 1, wherein the lease history of the plurality of leased vehicles includes a maximum number of lease deferrals.

7. The automatic lease deferral system of claim 1, wherein the computing device is further configured to determine whether the information pertaining to the weather event exceeds a weather event threshold.

8. The automatic lease deferral system of claim 1, wherein in response to prompting the customer within the electronic notification to accept the lease deferral, receiving an acceptance and updating the lease history of the eligible leased vehicle.

9. The automatic lease deferral system of claim 8, the computing device further comprising a machine learning model, wherein the machine learning model adjusts an algorithm of the computing device that determines the eligible leased vehicle based on the lease history.

10. The automatic lease deferral system of claim 1, wherein the one or more affected leased vehicles is determined by a geographic location of the plurality of leased vehicles.

11. A method for providing lease deferrals, the method comprising:
retrieving, from a weather reporting system, information pertaining to a weather event defined by a geographic area;
determining one or more affected leased vehicles from a lease history of a plurality of leased vehicles based on the geographic area of the weather event;
determining an eligible leased vehicle from the one or more affected leased vehicles for a lease deferral based on the weather event and the lease history of the one or more affected leased vehicles;
transmitting an electronic notification to a customer of the eligible leased vehicle, the electronic notification including a lease deferral offer; and
prompting the customer, within the electronic notification, to accept the lease deferral.

12. The method of claim 11, further comprising the electronic notification causing a user device to generate a push notification prompting a response to accept or deny the lease deferral.

13. The method of claim 11, wherein the electronic notification is a phone call prompting a response to accept or deny the lease deferral.

14. The method of claim 11, further comprising determining the eligible leased vehicle based on a history of lease payments.

15. The method of claim 14, further comprising determining the eligible leased vehicle based on a customer credit score.

16. The method of claim 11, further comprising determining the eligible leased vehicle based on whether a maximum number of lease deferrals has been exceeded.

17. The method of claim 11, further comprising determining whether the information pertaining to the weather event exceeds a weather event threshold.

18. The method of claim 11, further comprising:
receiving an acceptance; and
updating the lease history of the eligible leased vehicle.

19. The method of claim 11, further comprising determining the one or more affected leased vehicles by a geographic location of the plurality of leased vehicles.

20. An automatic lease deferral system, comprising:
a computing device comprising a memory unit storing a lease history of a plurality of leased vehicles, the computing device configured to:
retrieve, from a weather reporting system, information pertaining to a weather event defined by a geographic area;
determine one or more affected leased vehicles from the lease history of the plurality of leased vehicles based on the geographic area of the weather event;
determine an eligible leased vehicle from the one or more affected leased vehicles for a lease deferral based on the weather event and the lease history of the one or more affected leased vehicles;
transmit an electronic notification to a customer of the eligible leased vehicle, the electronic notification including a lease deferral offer; and
prompt the customer, within the electronic notification, to accept the lease deferral; and
a machine learning model, wherein the machine learning model adjusts an algorithm of the computing device that determines the eligible leased vehicle based on the lease history.
